(19) United States
(12) Patent Application Publication
(10) Pub. No.: US 2018/0349946 A1
(43) Pub. Date: Dec. 6, 2018

(54) SYSTEM, METHOD AND ARCHITECTURE FOR REAL-TIME NATIVE ADVERTISEMENT PLACEMENT IN AN AUGMENTED/MIXED REALITY (AR/MR) ENVIRONMENT

(71) Applicant: TELEFONAKTIEBOLAGET LM ERICSSON (PUBL), Stockholm (SE)

(72) Inventors: Ho Thanh Thao Nguyen, Palo Alto, CA (US); Meral Shirazipour, Santa Clara, CA (US)

(21) Appl. No.: 15/609,683

(22) Filed: May 31, 2017

(51) Int. Cl. G06Q 30/02; G06T 11/60

(52) U.S. Cl. CPC G06Q 30/0244; G06F 3/013; G06Q 30/0275; G06T 11/60

(57) ABSTRACT

A system, method and architecture for facilitating placement of native advertisements in an AR/MR environment. In one embodiment, the system is operative for receiving real world object identification and spatial mapping data relative to a plurality of real world scenarios sensed in respective AR sessions engaged by corresponding users using a plurality of AR devices. The real world object identification and spatial mapping data may be determined responsive to sensory and environmental information received from at least one of the AR devices and the corresponding users. Responsive to the real world object identification and spatial mapping data, one or more ads are obtained from an advertisement campaign management system that are contextualized within the respective real world scenarios.

### FIELD OF THE DISCLOSURE

The present disclosure generally relates to communication networks. More particularly, and not by way of any limitation, the present disclosure is directed to a system, method and architecture for facilitating real-time native advertisements in an augmented/mixed reality (AR/MR) environment.

### BACKGROUND

Increasingly, augmented and virtual reality (AR/VR) are becoming more than gaming environments, with companies finding enterprise potential in the technology in a host of applications. One of the goals of the industry is to replace conventional user interfaces such as keyboards, displays, etc. with new paradigms for human-machine communication and collaboration, thereby facilitate a major shift in user engagement in AR/VR environments. Accordingly, the enterprise potential of AR/VR technology continues to grow as companies are constantly exploring new use cases beyond pilot or “one-off” applications.

Mixed reality (MR) represents a further advance where both AR and real world environments may be merged in additional enhancements to provide richer user experiences. As the trends in AR/VR/MR deployment continue to grow apace, interest in marketing and monetizing the available digital “real estate” in AR/VR/MR environments has also grown concomitantly, albeit potentially within the constraints of efficient bandwidth utilization and optimization in an AR-supported network.

### SUMMARY

The present patent disclosure is broadly directed to systems, methods, apparatuses, devices, and associated non-transitory computer-readable media and network architecture for facilitating placement of native advertisements (or, ads for short) in an AR/MR environment. In one aspect, an example method includes, inter alia, receiving real world object identification and spatial mapping data relative to a plurality of real world scenarios sensed or otherwise detected in respective AR sessions engaged by corresponding users using a plurality of AR devices. The real world object identification and spatial mapping data may be determined responsive to sensory and environmental information received from at least one of the AR devices and the corresponding users. Responsive to the real world object identification and spatial mapping data, one or more contextualized ads are obtained from an advertisement campaign management system that are customizable within the respective real world scenarios. The claimed method further involves assigning the one or more advertisements to one or more of the plurality of AR devices, e.g., based on network flow optimization techniques. The ads are then inserted into the respective AR sessions of the one or more AR devices to which the advertisements have been assigned for placement relative to one or more real world objects perceived in the respective AR views displayed by the one or more AR devices.

In a further aspect, an embodiment of a system, apparatus, or network platform is disclosed which comprises, inter alia, suitable hardware such as processors and persistent memory having program instructions for executing an embodiment of the methods set forth herein.

In still further aspects, one or more embodiments of a non-transitory computer-readable medium or distributed media containing computer-executable program instructions or code portions stored thereon are disclosed for performing one or more embodiments of the methods of the present invention when executed by a processor entity of a network node, apparatus, system, network element, subscriber device, and the like, mutatis mutandis. Further features of the various embodiments are as claimed in the dependent claims.

Beneficial features of an embodiment of the present invention may include but not limited to one or more of the following: (i) the disclosed AR ad placement architecture is configured to learn the environment and detect objects that would match the relevant products and services to be advertised, in addition to identifying possible locations for those ads to be placed; (ii) the AR ad placement architecture allows for placement rules to be applied so the sponsored product(s) may be placed in a way that the experience of the consumer is not disrupted (i.e., the sponsored products look like native content in their natural “habitat”); (iii) the AR ad placement architecture may be configured to take into consideration consumer data for personalized native ad experience (i.e., two different consumers in the same environment may see different ads or views of the same ad); (iv) the AR ad placement architecture allows a natural integration within current ad exchange markets; and (v) the AR ad placement architecture can be readily scaled as the number of consumers with AR media connectivity continues to grow.

Additional benefits and advantages of the embodiments will be apparent in view of the following description and accompanying Figures.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example AR/MR network architecture for facilitating delivery and placement of real-time native advertisements in a subscriber's AR/MR device according to one or more embodiments of the present patent application;

FIG. 2A depicts a functional block diagram illustrative of various blocks, processes, network elements and/or apparatuses that may be (re)combined in one or more arrangements with respect to delivering real-time native advertisements in the AR/MR network architecture of FIG. 1 according to one embodiment;

FIG. 2B depicts further details of an advertisement placement management system (APMS) for use in the AR/MR network architecture of FIG. 1 according to one embodiment for purposes of the present patent application;

FIG. 2C depicts an example advertisement assignment scheme in an illustrative scenario according to one embodiment for purposes of the present patent application;

FIGS. 3A and 3B respectively depict an example real world environment and an AR/MR environment wherein native advertisements may be placed in relation to real world objects in a AR/MR display view according to an embodiment of the present patent disclosure;

FIGS. 4A-4C are flowcharts of various blocks, steps and/or acts that may be (re)combined in one or more arrangements, with or without additional flowcharts of the present disclosure, for facilitating delivery and placement of real-time native advertisements using environmental and sensory recognition according to one or more embodiments of the present patent disclosure;

FIG. 5 is a flowchart of various blocks, steps and/or acts that may be (re)combined in a still further arrangement for purposes of the present patent application; and

FIG. 6 depicts a block diagram of a computer-implemented apparatus that may be (re)configured and/or (re)arranged as a platform, node or element in an example AR/MR network architecture according to one or more embodiments of the present patent disclosure.

### DETAILED DESCRIPTION OF THE DRAWINGS

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that the embodiments of the present disclosure may be practiced without such specific components. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged or programmed under suitable executable code to perform that function.

As used herein, an AR/MR network element, platform or node may be comprised of one or more pieces of service network equipment, including hardware and software that communicatively interconnects other equipment on a network (e.g., other network elements, end stations, etc.), and is adapted to host one or more advertisement applications or services (hereinafter “ad applications” or “ad services”, or terms of similar import, for short) with respect to a plurality of subscribers. As such, some network elements may be disposed in conjunction with a wireless radio network environment whereas other network elements may be disposed in conjunction with a public packet-switched network infrastructure, including or otherwise involving suitable content delivery network (CDN) infrastructures and/or various Internet-based ad campaign management architectures. In still further arrangements, one or more network elements may be disposed in cloud-based platforms or datacenters having suitable equipment running virtualized functions or applications relative to various types of media, e.g., ads, AR/MR content, as well as other subscriber-specific or broadcast audio/video/graphics media including computer-generated or holographic content. Accordingly, at least some network elements may comprise “multiple services network elements” that provide support for multiple network-based functions (e.g., A/V media management, session control, Quality of Service (QoS) policy enforcement, bandwidth scheduling management, subscriber/device policy and profile management, content provider and AR publisher priority policy management, streaming policy management, network storage policy management, and the like), in addition to providing support for multiple application services (e.g., data and multimedia applications). Subscriber end stations, client devices or customer premises equipment (CPE) may comprise any device configured to execute, inter alia, an AR/MR client application and/or a HTTP-based download application for receiving live/stored AR content from one or more AR content providers as well as real-time AR-based native advertisements, e.g., via a suitable access network or edge network arrangement based on a variety of access technologies, standards and protocols. For purposes of one or more embodiments of the present invention, an example client device may therefore comprise any known or heretofore unknown AR/MR device including such as, e.g., a Google Glass device, Microsoft HoloLens device, etc., as well as holographic computing devices, which may or may not be deployed in association with additional local hardware such as networked or local gaming engines/consoles (such as Wii®, Play Station 3®, etc.), portable laptops, netbooks, palm tops, tablets, phablets, mobile phones, smartphones, multimedia/video phones, mobile/wireless user equipment, portable media players, smart wearables such as smartwatches, goggles, digital gloves, and the like. Further, the client devices may also access or consume other content/services (e.g., non-AR/MR) provided over broadcast networks (e.g., cable and satellite networks) as well as a packet-switched wide area public network such as the Internet via suitable service provider access networks. In a still further variation, the client devices or subscriber end stations may also access or consume content/services provided on virtual private networks (VPNs) overlaid on (e.g., tunneled through) the Internet.

One or more embodiments of the present patent disclosure may be implemented using different combinations of software, firmware, and/or hardware in one or more modules suitably programmed and/or configured. Thus, one or more of the techniques shown in the Figures (e.g., flowcharts) may be implemented using code and data stored and executed on one or more electronic devices or nodes (e.g., a subscriber client device or end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such network elements may typically include a set of one or more processors coupled to one or more other components, such as one or more storage devices (e.g., non-transitory machine-readable storage media) as well as storage database(s), user input/output devices (e.g., a keyboard, a touch screen, a pointing device, and/or a display), and network connections for effectuating signaling and/or bearer media transmission. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device or network element may be configured to store code and/or data for execution on one or more processors of that element, node or electronic device for purposes of implementing one or more techniques of the present disclosure.

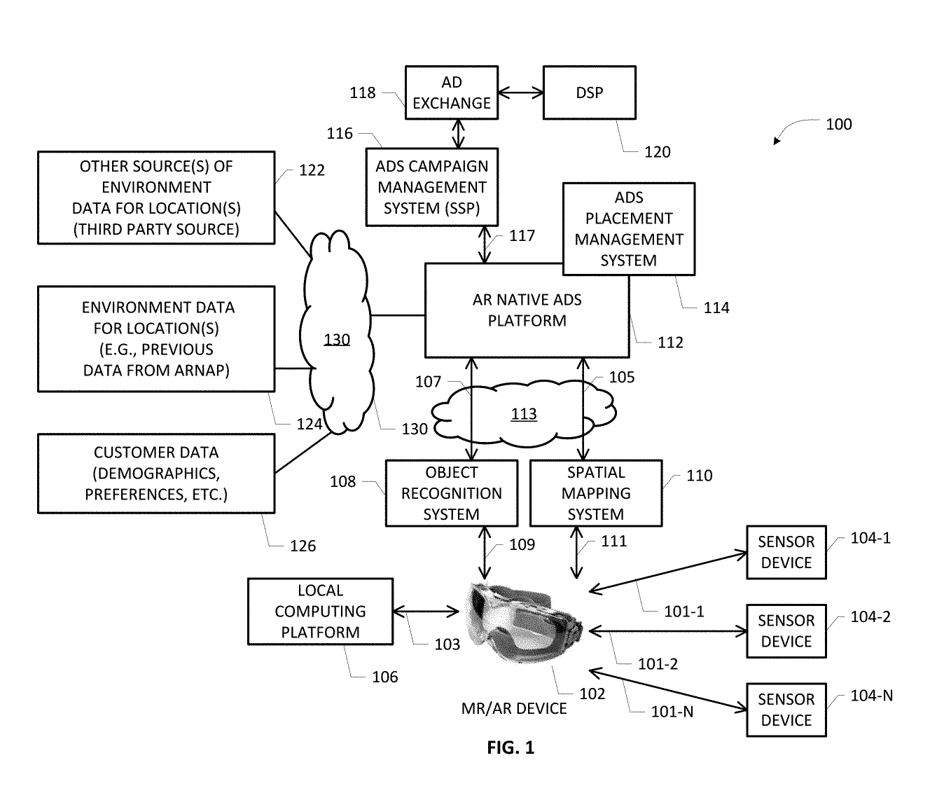

Referring now to the drawings and more particularly to FIG. 1, depicted therein is an example AR/MR network architecture 100 for facilitating delivery and placement of real-time native advertisements in a subscriber's AR/MR device according to one or more embodiments of the present patent application. It should be appreciated that the terms “augmented reality” or “AR” and “mixed reality” or “MR” may be used somewhat interchangeably for purposes of an embodiment of the present invention. Further, where only “AR” or “MR” is mentioned, it will be realized that these terms represent both AR and MR, cumulatively or otherwise. In the context of the present patent disclosure, augmented reality (AR) is a technology where the real world and its physical objects, images, senses, sounds, and other tangible quantities in a physical environment that is viewed, sensed, heard, or otherwise perceived by a user using a suitable display/computing device and other related hardware is augmented or supplemented with or by virtual objects or other computer-generated sensory input such as sound, video, graphics, olfactory and tactile sensory data, as well as suitable GPS data in some cases. In a general sense, AR may be an overlay of content on the real world, but that content may or may not be anchored to or part of the physical view or its objects. On the other hand, virtual reality (VR) uses computer technology to create a simulated environment in which the user/consumer/subscriber is completely immersed in the simulated experience. In a virtual reality environment, all the visuals are digitally produced and there is typically no interaction with the real world. More broadly, embodiments of the present invention may treat mixed reality (MR) as a mix of AR and VR, sometimes also referred to as “hybrid reality” that involves a merging of real and virtual worlds to produce new environments and visualizations where physical and computer-generated objects, sounds, images, etc. (collectively, “entities”) may coexist and even interact in real time. In other words, MR can be considered an overlay of synthetic entities or content on the real world environment that are anchored to and interact with the physical objects/entities therein in some meaningful fashion. Thus, in an MR environment, an embodiment may not only allow for the merger of digital objects within a real world scenario but also facilitate extra real life textural, tactile, olfactory, visual, aural, or other sensory feedback such as “depth” or “surfaces”.

By way of illustration, an example AR/MR device 102 is depicted as a client device operative with advanced AR/MR technologies including, e.g., computer/machine vision and object recognition, in addition to inter-operating with various sensory devices 104-1 to 104-N, at least some of which may be integrated within the client device 102 in an embodiment. Where such sensory devices may be provided as separate entities or elements, they may communicate with the client AR/MR device 102 using suitable wired and/or wireless communications technologies, e.g., optical, radio, Bluetooth, etc., for generating, receiving and/or transmitting myriad types of sensory data and associated control signaling, via applicable communication paths 101-1 to 101-N. Additionally, alternatively, or optionally, a local computing platform 106 (i.e., hardware, operating system software/firmware and applications) 106 may also be coupled to the client AR/MR device 102 via a suitable communication path 103, wherein the local computing platform 106 may represent any number and/or type of desktop computers, laptops, mobile/smartphones, tablets/phablets, smart TVs including high definition (HD), ultra HD (UHD), 4/8K projection/display devices, set-top boxes (STBs), holographic computers, other media consumption devices, etc. Collectively, the local computing hardware/software 106, client AR/MR device 102 and associated sensory devices 104-1 to 104-N may be considered a client AR/MR platform within the AR network architecture 100, which may include or interface with a plurality of such client platforms (e.g., hundreds of thousands, depending on scale). With respect to the sensory devices 104-1 to 104-N, example devices may include but not limited to cameras, microphones, accelerometers, Global Positioning System (GPS) locators, touch sensors, mood sensors, temperature sensors, pressure sensors, gesture sensors/controllers, optical scanners, near-field communications (NFC) devices, head movement detectors, ocular movement trackers, and directional sensors such as solid-state compasses, etc., as well as wearable devices comprising health/exercise monitors and biometric identification devices, and so on. Further, a subset of sensors may be provided as part of an Internet of Things (IoT) environment associated with the AR/MR device 102. In a typical arrangement, for instance, a head-mounted display (HMD) may be included as part of the AR/MR client device 102, which may be paired with a helmet or a harness adjustable to the user, and may employ sensors for six degrees-of-freedom monitoring that allows alignment of virtual information to the physical world perceived in a field of view (FOV) and adjust accordingly with the user's head and/or eye movements. An example AR/MR client device 102 may also be rendered on devices resembling eyewear or goggles that include cameras to intercept the real world view and redisplay its augmented view through an eye piece or as a projected view in front of the user. Such devices may include, but not limited to, smartglasses such as, e.g., Google Glass, Microsoft HoloLens, etc., as well as bionic/electronic contact lenses and virtual retinal displays. A separate head-up display (HUD) may also be implemented in association with an example AR/MR client device 102 depending on the specific AR/MR application, AR/MR content provider, and/or the AR/MR client platform implemented in an embodiment.

In accordance with the teachings of the present patent disclosure, an Object and sound Recognition System (ORS) 108 and a Spatial Mapping System (SMS) 110 may be integrated or otherwise co-located with the client AR/MR device 102 in an example embodiment. In an alternative or additional embodiment, ORS 108, SMS 110 or both may be provided as separate network infrastructure elements disposed in an edge/access network servicing the user/subscriber associated with the client AR/MR device 102, communicatively operating therewith using suitable wired/wireless communication paths 109, 111, respectively. In a still further embodiment, ORS 108 and/or SMS 110 may be implemented as a virtual functionality or appliance in a cloud-based implementation. In one embodiment, irrespective of the specific implementation, ORS 108 may be configured as a system, apparatus or virtual appliance that is operative, depending on available sensors and/or other peripherals associated with an example AR/MR device 102, for collecting information about physical objects, sounds, smells, brands, consumer's mood, etc. in the real world environment perceived by the user (collectively referred to herein as “sensory and environmental information”). In one example arrangement, AR/MR device 102 may use microphones and different types of cameras to recognize the sounds, objects, brands and feed the data to ORS 108. As noted previously, an example AR/MR device may also include biometrics-based sensors that may be configured to provide suitable information that may be used to determine the mood of the AR user/consumer. Depending on where an example implementation of ORS is located, the processing of the sensory/environmental data may be effectuated locally on the AR/MR device 102, its local computing platform 106, or on the network edge/cloud infrastructure where the sensory/environmental data may be transmitted via cellular, WiFi and/or other types of connectivity. Skilled artisans will realize that various known or heretofore unknown techniques may be employed for processing the sensory/environmental data (e.g., image recognition, pattern recognition, machine vision techniques, etc.) so as to identify/recognize the existing physical world objects, images, sounds, etc. in relation to a real world view seen/perceived via the AR/MR device 102 and generate real world object identification data. As will be set forth in further detail below, an AR-based advertisement infrastructure element 112, referred to herein as AR Native Ads Platform or ARNAP, is operative to receive the real world object identification data, among other pieces of information, for purposes of selection and/or suggestion of applicable advertisement content in a programmatic manner in conjunction with one or more additional network modules or elements according to an embodiment of the present invention.

Continuing to refer to FIG. 1, SMS 110 may be configured as a system, network element, or a cloud-based virtual appliance operative to detect or otherwise identify surfaces and objects in the real world environment perceived in a FOV of the client AR/MR device 102. In one example embodiment, SMS 110 is further operative to map the physical objects, i.e., where they are relative to one another in the FOV. For example, the FOV may be constantly changing in relation to the head/ocular movement of the user as well as depending on whether or not the user is also moving (i.e., walking, running, etc.). Accordingly, SMS 110 may be configured to dynamically map or remap the physical objects identified in the changing FOV and provide the spatial relationships among the physical objects to the ARNAP node 112. As with ORS 108, one skilled in the art will realize that a number of various known or heretofore unknown techniques may be employed for performing spatial mapping of the physical objects (e.g., using depth/perception sensors, movement sensors, etc.), which data may be dynamically and/or programmatically updated (e.g., based on pre-configured update triggers). Essentially, the SMS module 110 is configured to perform spatial mapping of the physical environment in order to understand where the objects are in the real world and how the environment is laid out (e.g., surfaces and spaces, relative distances and orientations in a 2D/3D view) and provide the spatial mapping data to the ARNAP node 112. Further, depending on where an example implementation of SMS functionality is located, the processing required for spatial mapping of the physical environment may be effectuated locally on the AR/MR device 102, its local computing platform 106, or on the network edge/cloud infrastructure. Whether ORS 108 and/or SMS 110 are co-located with the AR/MR device 102 or implemented as network nodes in a suitable infrastructure, real world object identification data and/or spatial mapping data may be provided to and received by the ARNAP node 112 via applicable communication network(s) 113 that effectuate suitable communication paths 107, 105, respectively, based on a variety of wired/wireless communication technologies, e.g., broadband cable, satellite technologies, cellular technologies (3G/4G/5G or Next Generation), WiFi, Bluetooth, etc.

In some embodiments of the present invention, the functionalities of ORS 108 and SMS 110 may also be integrated or otherwise co-located. Broadly, ORS and SMS may inter-operate together wherein the coordinates of a real world environment and the physical objects therein may be derived or generated using a combination of techniques involving computer vision, video tracking, visual odometry, etc. In a first or initial stage, the process may involve detecting interest points, fiducial markers, or optical flow in the sensed camera images, wherein various feature detection methods such as corner detection, blob detection, edge detection, and other image processing methods may be employed. In a follow-up or second stage, a real world coordinate system and the location/positioning of the physical objects therein may be restored from the data obtained in the first stage, using techniques including but not limited to simultaneous localization and mapping, projective/epipolar geometry, nonlinear optimization, filtering, etc. In an example implementation, AR Markup Language (ARML) may be used to describe the location and appearance of the objects in an AR/MR scenario.

In accordance with the teachings herein, ARNAP 112 may be interfaced with an Advertisement Campaign Management System (ACMS) 116 via a suitable interface 117, wherein ACMS 116 is operative to manage one or more ad campaigns in association with an applicable advertisement architecture, e.g., including, but not limited to, an architecture similar to web-based advertising. In one arrangement, ACMS 116 may be configured as a supply-side platform (SSP) of an advertisement architecture that interacts with existing demand-side platforms (DSPs) 120 via one or more ad exchanges 118. As an SSP or at least as part thereof, ACMS 116 may be implemented as a technology platform that enables AR content publishers to manage their advertising space inventory, fill it with ads and monetize revenue accordingly. For example, ACMS 116 may be configured to provide impression-level bidding based on the data generated by ARNAP 112, preferably contextualized and customized in an AR/MR environment according to an embodiment of the present invention as will be described in detail further below. In one example implementation, DSP 120 may be realized as a technology platform that allows buyers to purchase digital inventory, e.g., ad spaces in an AR/MR environment, from various ad exchanges and ad network accounts in a number of ways, including but not limited to real-time bidding (RTB) where digital inventory may be bought and sold on per-impression basis, via programmatic instantaneous auction, also contextualized in an AR/MR environment according to an embodiment of the present invention. Accordingly, a publisher content server and/or a publisher ad server may be provided as part of the functionality of ARNAP 112 in an example embodiment of the present invention, although such entities may also be deployed as separate entities depending on a particular AR-based advertisement architecture implementation.

For purposes of the present invention, native advertising is a type of advertising where the advertisement is presented in a disguised/non-intrusive manner, e.g., the ad content at least substantially matches the form/function of a real world scenario displayed or otherwise perceived in an AR/MR environment. In example cases, native ads may manifest as articles or products, although not necessarily limited thereto, produced by an advertiser with the specific intent to promote a product. Accordingly, in an embodiment of the present invention, native advertising may be contextualized with respect to the various physical objects, images, sounds, smells, etc. and/or the AR content that may be superimposed on the real world view presented in an AR application. It should be appreciated that the term “native” may therefore refer to this contextualized coherence of the ad content with the other media and/or tangible entities appearing in a dynamically varying AR environment. The ad exchange 118 and/or DSPs 120 may be provided with suitable application program interfaces (APIs) and associated data structures to request AR native ads spaces according to the teachings herein for purposes of an example embodiment as will be set forth in detail further below.

In a further arrangement, ARNAP 112 may also be interfaced with various additional sources of data, which may be hosted or managed by one or more third-party networks, entities, private/public enterprises, or operators, whereby user/subscriber profiles, past AR/MR environment and usage data pertaining to the subscribers, and other third-party data may be selectively/optionally utilized in selecting, assigning and placing native AR ads in an example embodiment of the present invention. Subscriber-based factors forming a user profile may comprise any combination or sub-combination of parameters/variables such as subscriber demographics including, but not limited to, subscriber personal data such as names, age(s), gender(s), ethnicities, number of individuals in the premises or size of the household, socioeconomic parameters, subscribers' residential information (i.e., where they live—city, county, state, region, etc.), employment history, income or other economic data, spending habit data, consumption data and product preferences, social media data/profiles, religion, language, etc., which are collectively shown at reference numeral 126. Environment data 124 obtains past and/or present data for the AR environments in different geolocations, which may be used in an example embodiment to enhance the real-time ORS data for the respective users/subscribers. For instance, another AR user/device nearby may also be connected and their data can be used as well by ARNAP 112, especially if the environment data from other AR user/device is of better quality, for example. Past environment data can be useful from a historical perspective, which could come from current user AR device sensors or others in the same location or vicinity. Other third-party data sources 122 may comprise or provide additional information relative to the subscribers' geolocations, e.g., ambient environmental/weather or climate data, news, and other location-based data. One skilled in the art will recognize that these various additional data sources 122, 124, 126 may be disposed or deployed at different parts or nodes of the AR network architecture 100, and may therefore be provided with appropriate communication networks 130 for communicating with ARNAP 112.

Regardless of where such data sources are disposed, it should be understood that the various pieces of information from them may be selectively/optionally utilized by ARNAP 112 in conjunction with other modules of the AR network architecture 100 depending on a policy-based management system that may take into consideration an assortment of factors such as the scope/extent of a particular ad campaign, AR content in respective AR environments, subscribers' geolocations, licensing and/or other geographical/temporal restrictions, and the like.

In one arrangement, ARNAP 112 may be configured to detect, obtain, receive, monitor or utilize various types of sensory/environmental data as well as real world object identification and spatial mapping data for native placement of ads in AR environments, (e.g., subscribers with active AR connections or sessions), wherein the ads may be received based on pre-cached ad bids and/or RTB-based ad bids from one or more DSPs 120. Associated with ARNAP 112 is a sub-system, module or apparatus 114, referred to herein as Advertisement Placement Management System (APMS), which may be integrated with or provided separately from ARNAP 112, for facilitating rule-based placement logic with respect to the selected ads in relation to one or more real world objects/entities perceived by respective AR subscribers in corresponding AR/MR environments. In an example implementation, APMS 114 may be provided with configurable rules (e.g., policy-based) for native ad placement. For example, if the objective is to place an ad for a pair of running shoes (that is, assuming that ACMS/SSP 116 is configured to provide or fill one or more suitable locations for the shoes from a shoe supplier based on an exchange-mediated ad transaction), APMS 114 may be configured to identify matching objects that represent suitable placeholders for the shoes ad in the real world environment of an AR/MR environment. In an illustrative scenario, the rules-based recommendations from APMS 114 may contain other details such as placing the advertisement next to real world shoes in an empty space (i.e., devoid of a physical object, or separate from other physical objects by a predetermined marginal space, etc.). In accordance with the teachings of the present invention, ARNAP 112 is operative to compile the recommendations received from APMS 112 and determine an optimal decision as to which ads to be placed and where to place them. As noted previously, since the functionality of APMS 114 may be integrated within ARNAP 112 some deployments, the overall ad placement service logic may be executed by or at ARNAP 112 without having to engage in external service/functional calls.

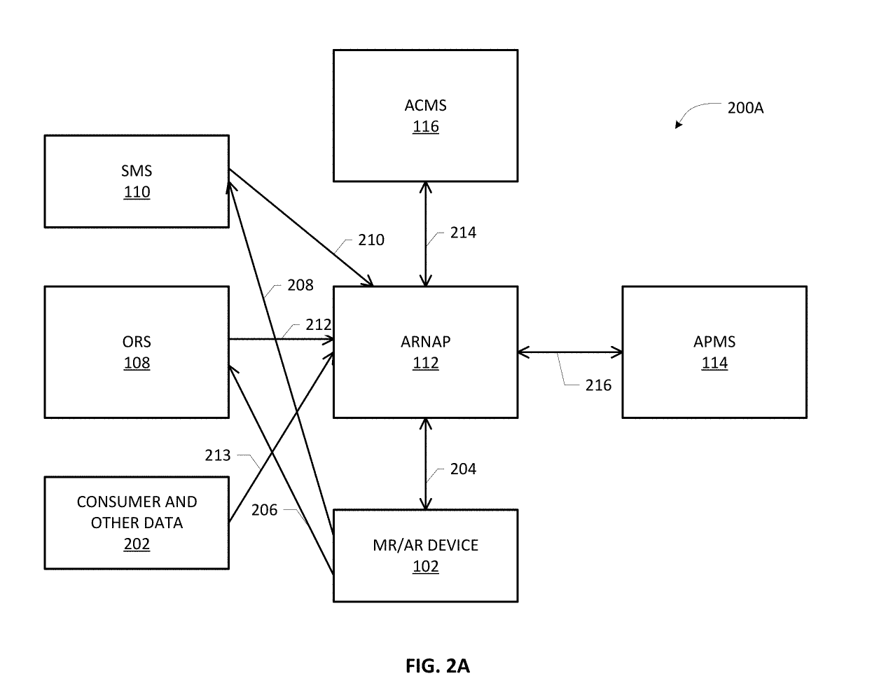

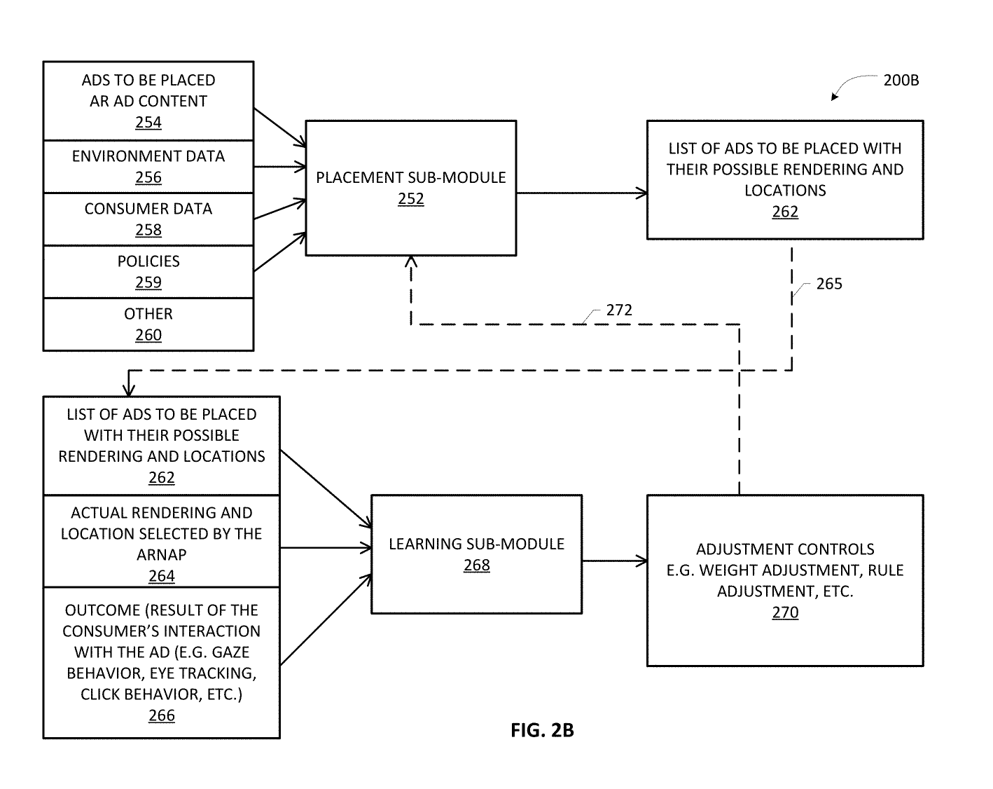

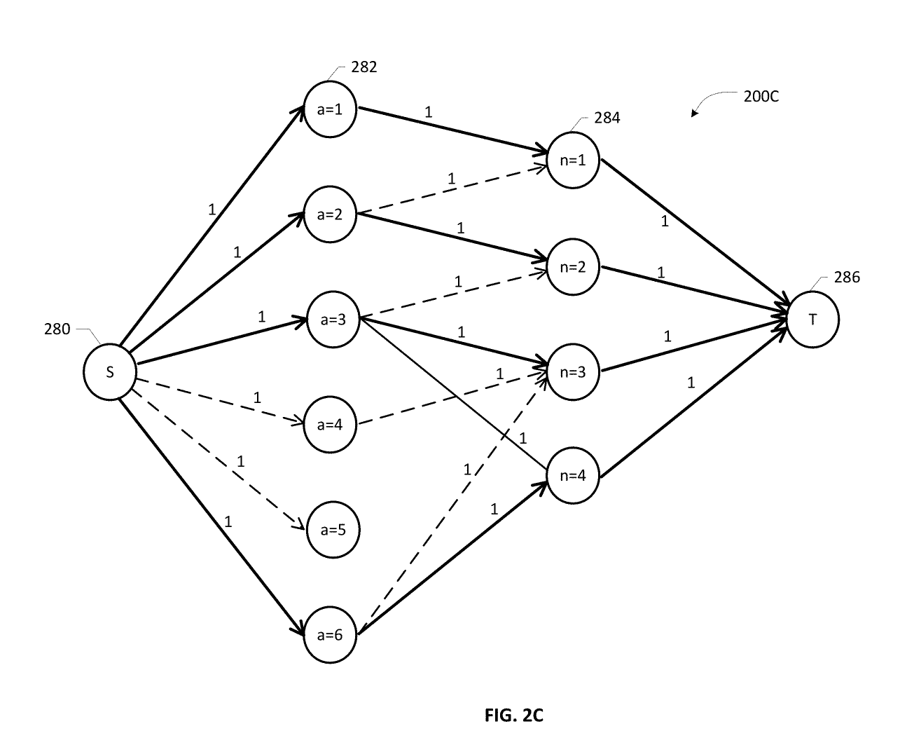

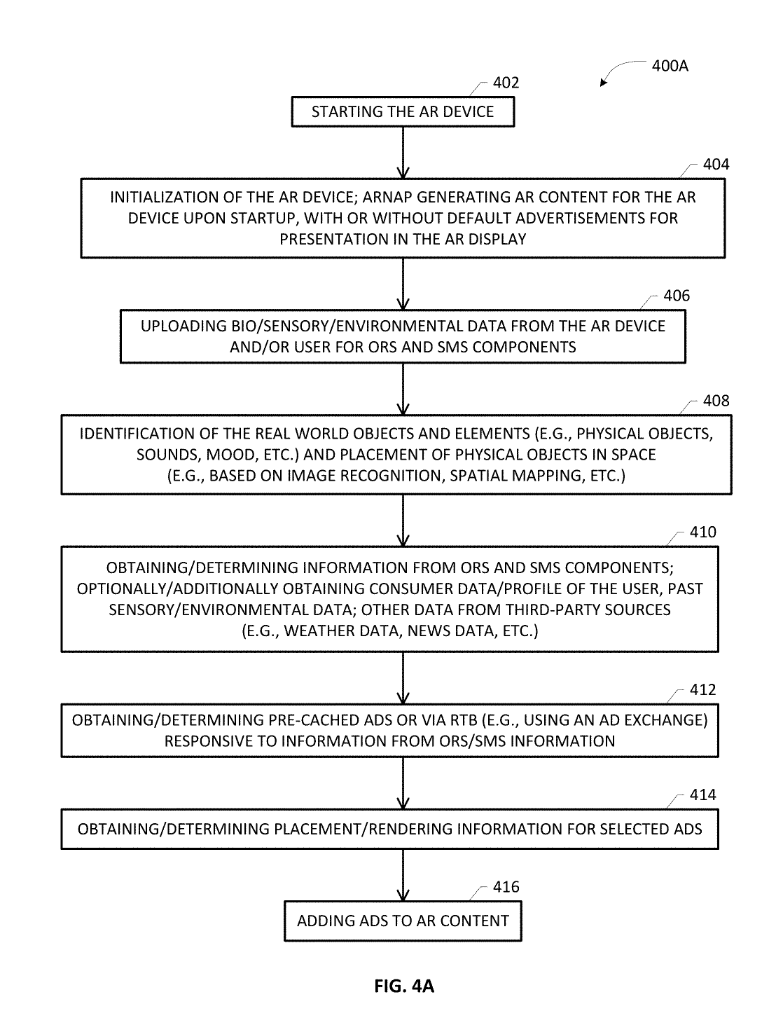

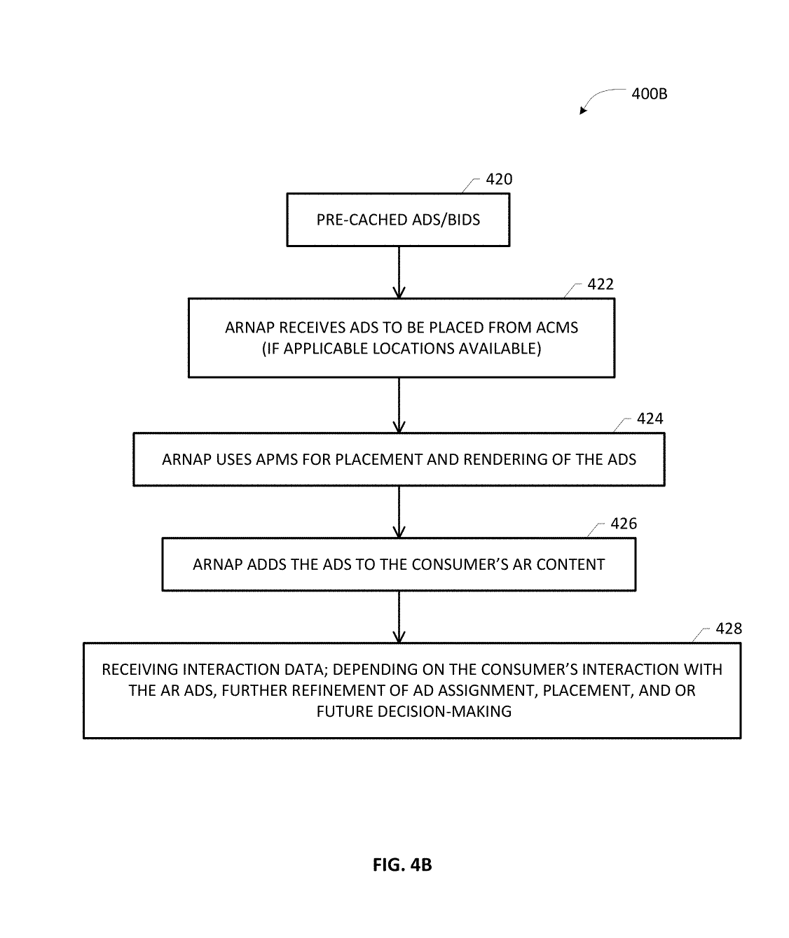

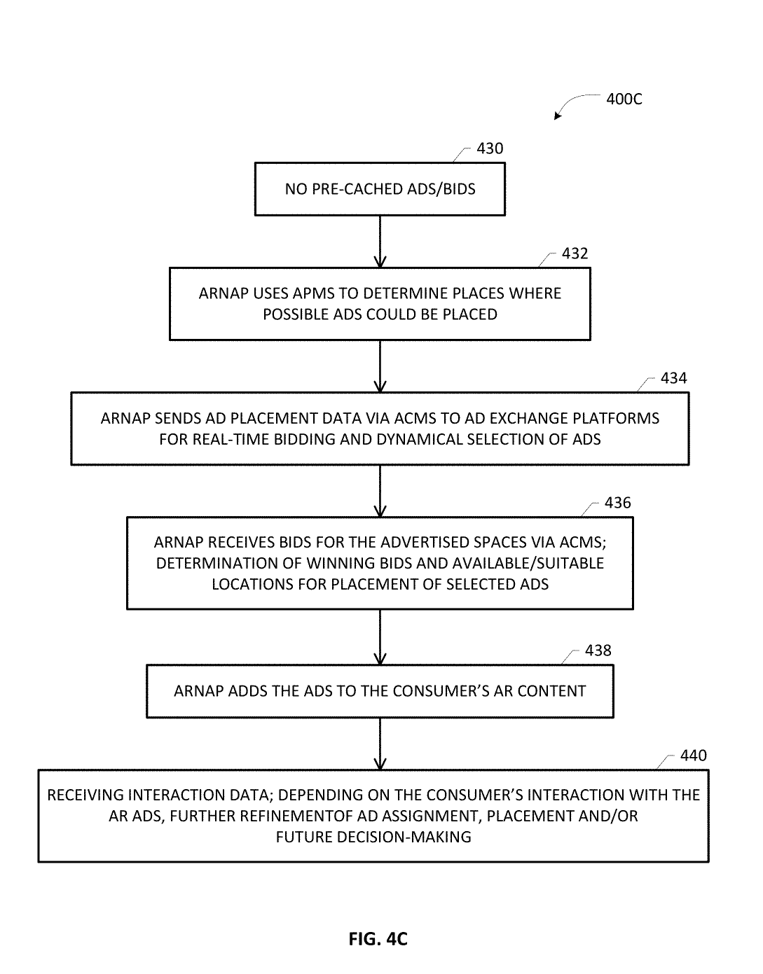

FIG. 2A depicts a functional block diagram pertaining to a high-level system 200A including various blocks, modules, network elements and/or apparatuses that may be (re)combined in one or more arrangements, including optionally in a cloud-based implementation, in respect of delivering real-time native advertisements in the AR/MR network architecture of FIG. 1 according to one embodiment. FIGS. 4A-4C are flowcharts of various blocks, steps and/or acts that may be (re)combined in one or more arrangements, with or without additional flowcharts of the present disclosure, for facilitating delivery and placement of real-time native advertisements using environmental and sensory recognition in a system 200A of FIG. 2A according to an embodiment of the present patent disclosure. In the block diagram of FIG. 2A, a number of communication interfaces among the blocks of system 200A are illustrated for effectuating the various process flows and/or steps of process 400A at relevant stages involving respective entities. Respective interface(s) 204 are operative for communications (i.e., control plane and/or user plane communications) between one or more consumer devices (e.g., an AR/MR device 102) and ARNAP 112. Interfaces 206 and 208 are representative of communication paths between the AR/MR device(s) 102 and ORS 108 and SMS 110, respectively. Interfaces 212 and 210 represent communication paths between ORS 108 and SMS 110 and ARNAP 112, respectively. Interface 214 is likewise representative of communication paths between ARNAP 112 and ACMS 116. Reference numeral 216 refers to an interface disposed between ARNAP 112 and APMS 114. Reference numeral 202 cumulatively refers to the other data sources 122, 124, 126 shown in FIG. 1, and may optionally communicate with ARNAP 112 via interface(s) 213 disposed therebetween.

As noted previously, communications between the entities of system 200A may include control plane signaling communications, user plane data communications, or both. Further, flow of information on any communication interface may be unidirectional or bidirectional unless otherwise specifically described.

Taking FIG. 2A and FIG. 4A together, an example process flow 400A according to an embodiment may be set forth as follows. At block 402, a subscriber/consumer turns on a client device (e.g., AR/MR device 102) for starting an AR session or service. Upon initialization of the AR device(s), ARNAP 112 may be configured to generate or provide suitable AR content from an AR publisher for the respective AR/MR device 102 depending on the AR application launched by the subscriber (block 404). In one arrangement, ARNAP 112 may provide the AR content upon startup, with or without default advertisements for presentation in the AR display. As the AR/MR device 102 is turned on (or at some point after commencing the AR session), various pieces of biometric, sensory and/environmental data from the AR/MR device 102 and/or associated sensors and peripherals may be uploaded (either automatically or manually under user control) to ORS 108 and/or SMS 110 via respective interfaces 206, 208 (block 406). As noted previously, ORS 106 and/or SMS 110 may use various techniques to identify the real world objects and elements (e.g., physical objects, sounds, mood, etc.) and spatially map their placement in a real world scenario seen in the AR environment (block 408). At block 410, ARNAP 112 receives, determines or otherwise obtains information from ORS 108 and SMS 110 via interfaces 212, 210 respectively. Optionally/additionally, ARNAP 112 may also obtain, determine or receive consumer data/profile of the user, past sensory/environmental data, and other data from third-party sources 202 via respective interfaces 213. Responsive to the information from ORS 108, SMS 110 and/or data sources 202, ARNAP 112 operates in conjunction with ACMS 116 and APMS 114 via interfaces 214 and 216 for obtaining/determining or otherwise selecting pre-cached ads or via RTB as set forth at block 412. In one arrangement, an existing Internet ad architecture (e.g., using an ad exchange) may be reconfigured for placing native ads in an AR environment wherein ACMS 116 operates as an SSP. Whereas ARNAP 112 may be integrated with AR publisher content servers (and thereby generate non-ad-related AR content) in an exemplary embodiment, skilled artisans will recognize that such an integration is not necessary and separate AR publisher content servers may therefore be interfaced via ARNAP for providing appropriate AR content to the respective AR consumers. At block 414, ad assignment and placement information with respect to different AR geolocations may be obtained or otherwise determined for the selected ads depending on suitable placement optimization process, which will be set forth in additional detail below. Furthermore, rendering information may be obtained or otherwise determined for the placed/assigned ads (e.g., best ad content, format, display time, placement within a real world environment, etc.), as also set forth in block 414. ARNAP 112 adds or otherwise inserts the ads in the consumers' respective AR content sessions, which may use or include the rendering information with respect to the ads to be inserted (block 416).

Depending on whether or not the ads are obtained responsive to pre-cached bids, different configurations for ad fulfillment may be obtained in an embodiment within the scope of the present invention. Process 400B in FIG. 4B is representative of a flow where pre-cached bids are implemented (block 420). In this embodiment, ARNAP 112 may be configured to continuously receive ads to be placed from ACMS 116 via interface 214, for example, if there are applicable AR geolocations are determined to be available (block 422). At block 424, ARNAP 112 uses APMS 114 for determining placement and rendering of the ads, which are then added to the AR content of one or more AR environments, respectively (block 426). In a further variation, ARNAP 112 may be configured to receive various pieces/types of interaction data, and depending on the respective consumers' interactions with the placed native ads, a learning module associated with ARNAP 112 and/or APMS 114, may further refine ad selection, assignment and placement techniques in a feedback loop for future decision-making (block 428), as will be set forth in additional detail below.

Process 400C in FIG. 4C is representative of a flow where no pre-cached ads/bids are provided. Upon determining that there are no pre-cached ads/bids (block 430), ARNAP 112 uses APMS 114 to determine the optimal places and/or geolocations where possible ads could be placed, i.e., determination of potential digital ad space inventory in the AR/MR environments (block 432). Upon obtaining the relevant results from APMS 114, ARNAP 112 sends the ad placement data to ACMS 116 via interface 214, which then interacts with one or more ad exchanges (e.g., ad exchange 118 in FIG. 1) for facilitating real-time bidding and dynamic selection of ads based on appropriate ad revenue and monetization techniques (block 434). At block 436, ARNAP 112 receives bids for the advertised spaces via ACMS 116. Responsive thereto, ARNAP 112 determines a selection of the winning bids received from ACMS 116, in addition to making a determination as to where and how the ads corresponding to the winning bids are to be placed (block 436). Based on the placement and rendering information, ARNAP 112 adds the dynamically selected ads to the AR content of respective consumers operating in corresponding AR environments (block 438). Similar to the processes set forth at block 428 of process 400B, RTB-based ads placed in the AR environments may be interacted with by different consumers in different ways, where the consumer behavior may be provided in a feedback mechanism to appropriate learning modules for further training and refining the ad selection, assignment and placement techniques for future decision-making (block 440).

Turning to FIG. 2B, depicted therein is an example embodiment of an APMS component or module 200B that illustrates further details according to the teachings of the present patent application. As noted previously, APMS 200B may be embodied as a separate entity or integrated within a platform such as ARNAP 112 shown in FIGS. 1 and 2. A placement module, sub-system or sub-module 252 is operative to receive or otherwise obtain a number of inputs, exemplified as a list of ads to be placed (i.e., AR ad content) 254, AR environmental data 256 relative to subscribers' AR environments, subscriber/consumer profile data 258, ad policy management data 259, as well as various pieces of other, possibly third-party data 260, at least part of which inputs may be mediated via ARNAP 112 where APMS 200B is deployed as a separate network entity. By way of illustration, ad policy data 259 may include a policy depending on the type of media being consumed by the user (e.g., show a merchant's ads only when the consumer is watching sports). In such a scenario, content media type information may also be provided as input to the placement sub-module 252 (e.g., as part of data input 260). Where the AR content is produced (or mediated) by ARNAP, that information may already be available. On the other hand, if another entity generates AR content, the media type information could be provided as an input from a third party source. Responsive to the various pieces of input data, the placement module 252 is operative to determine an output list of possible ads 262 along with possible rendering information and locations, which is provided to or used by ARNAP 112 for further selection, optimization, filtering and insertion into appropriate AR content streams as described hereinabove.

In a further or optional arrangement, a learning sub-module, module or sub-system 268 may be provided as part of APMS 200B for effectuating a trainable “expert system” that can learn from, inter alia, subscribers' respective interactive behaviors relative to the ads natively placed in their AR environments. As illustrated in FIG. 2B, the learning module 268 may also receive the list of possible ads 262 and possible rendering and location information determined by the placement module 252, via a feedback/feed-forward loop path 265. Additionally, alternatively, and/or optionally, the learning module 268 may also receive or otherwise obtain further input data, e.g., actual rendering/location selection data 264 (e.g., provided by ARNAP), in addition to the consumer interactive data 266 (e.g., in relation to the native ads and/or the AR content in respective AR environments). By way of example, the consumer interactive behavior may be detected, monitored or otherwise determined based on a variety of dynamic and static components, including but not limited to, gaze behavior, eye/pupil tracking (e.g., pupil dilation, etc.), click behavior (e.g., selecting or highlighting an ad using an input device such as a mouse, digital glove, microphone, etc.), voice command inputs, bio/physiological cues, and the like. One skilled in the art will recognize that various techniques such as, e.g., “big data” analytics, machine learning, artificial intelligence, neural networks, fuzzy logic learning, pattern recognition and related techniques may be employed in a suitable combination or sub-combination with respect to effectuating a learning process as part of the learning module 268. Responsive to the inputs 262, 264, 266, the learning module 268 is operative to generate appropriate feedback control signals as output 270 that can be fed back as adjustments or refinements to the placement module 252 via a feedback path 272, e.g., with respect to modulating, modifying or otherwise (re)adjusting one or more parameters, variables, rules, priority values, or weights, that may be used in a specific implementation of a placement process.

As noted above, possible ads to be placed may be received by ARNAP 112 based on whether pre-cached bids or RTB-based ads are obtained from ACMS 116. Accordingly, the ad content input 254 to the placement module can be either actual bid for ads received from the ACMS or a list of potential ads that the ARNAP foresees will need placement and would like to advertise the space(s) to the ad exchange via the ACMS. As to the policy-based inputs 259, ARNAP 112 may be configured to include, generate and/or provide a number of advertisement policies. For example, a policy may be to avoid ads of certain type for certain consumer groups or to prioritize ads of certain type for given AR environments. ARNAP 112 may also include “metering” or access control policies, e.g., a policy for showing fewer ads or no ads to certain consumers during certain hours or at certain locations, etc. Other data 260 may also include data relating to black listed ads for certain locations or consumer groups, and the like.

Set forth below are example data formats with respect to the various input data described above, which may be used to extend existing ad server APIs for implementing an embodiment of a system or architecture for facilitating native ads in an AR environment according to the teachings of the present disclosure. Whereas the below example formats are provided in a JavaScript Object Notification (JSON) format for sample data objects, it should be appreciated that the format type and/or ad content examples are illustrative only and therefore are non-exhaustive and non-limiting.

An example consumer data object may be formatted as below:

```
{
  “ID”: 123,
  “location”: {“type”: “Point”, “coordinates”: [37.0, −121]},
  “gender”: “male”,
  “age”: 25,
  “preferences”: {
    “brands”: [“adidas”, “nike”, “apple”],
    “colors”: [“blue”, “white”],
    “music”: [“Classical”, “hip hop”],
  }
}
```

An example environment data object may be set forth as below:

```
{
  “ID”: 443,
  “locationtype”: {“type”: “Point”, “coordinates”: [102.0, 0.5]},
  “type”: {
    “type”: “private”,
    “setting”: “living room”
  },
  “objectsdetected”: [“table”, “sofa”, “carpet”, “shoerack”, “mirror”],
  “temperature”: 15,
  “light condition”: “low”,
  “sound condition”: “loud”
}
```

And example AR ad content data object may be set forth as below:

```
{
  “ID”: 7543435234,
  “description”: {
  “type”: “clothing”,
  “item”: “running shoes”
  },
  “target audience”: {
  “gender”: “male”,
  “agerange”: “20-35”,
  “preferences”: {
    “brands”: [“adidas”, “nike”, “apple”],
    “colors”: [“blue”, “white”],
    “music”: [“Classical”, “hip hop”],
    “rendering”: {
    “colors”: [“white”, “black”, “gold”],
    “sizes”: [“7-14”]
    }
  }
  }
}
```

As described previously, output of the placement module 252 preferably comprises the list of native ads 262 to be placed in respective AR environments. In one arrangement, such output 262 may include a single placement option per ad or a list of possible placement locations per ad. Skilled artisans will recognize that other variations, alternatives, modifications, and the like (e.g., geolocation targeting, subscriber targeting, AR content-specific ad selection, etc.) with respect to the output list 262 are possible within the scope of the present invention. In a still further arrangement, ARNAP 112 may be configured to provide an additional level of filtering or determination as to selecting which ad(s) to be placed where (e.g., AR geolocations), based on the output list 262 provided by APMS module 200B. An example AR-rendered ad data object may be set forth as below, again without any limitation as to the type of format and/or content:

```
{
  “ID”: 7543437979,
  “addcontent ID”: 7543435234,
  “description”: {
  “type”: “clothing”,
  “item”: “running shoes”,
  “brand”: “adidas:”,
  “size”: 10,
  “renderedcolor”: “white”,
  “consumerID”: 123,
  “renderedlocation”: {
    “type”: “shoestand”,
    “location”: “top”,
    “renderedlocationID”: [456, 221, −123]
  }
  }
}
```

In an example embodiment of the present invention, the placement module 252 may be configured to assign, or place, the ads to the various AR consumers/locations based on a network flow optimization technique wherein a flow metric associated with a logical graph constructed for the universe of the AR consumers (or, AR devices or locations) served by ARNAP 112. By way of illustration, an optimization process may be implemented as follows:
Stage A-Start with
   The list C of consumers and their given environment and its surrounding objects.
   The list of ad types (e.g., category 1, 2, 3, . . . , k, that could represent clothing, kitchen item, home decor, etc.).
   The list A of ads to be placed (a ads)
Stage B-Build
   a set N of possible locations n.
   for each location n, add the list of ad categories it can host.
Stage C-Build a Graph
   Create a node for every a in A.
   Create a node for every n in N.
   Connect every node a to all possible nodes n only if location n could host ad in node a.
   Assign a weight/capacity w^{n,a}, for example of 1, to each link.
   Add a source node S and connect it to all nodes a in A. The link weight/capacity should be infinite or 1.
   Add a sink node T and connect all nodes n in N to the sink node. The link weight/capacity should be the maximum weight among all the links coming into node n (1 in this case).
Stage D—Use a flow metric technique to compute the maximum flow in the graph.

Upon executing a placement/assignment process based on a flow metric, a flow solution may be obtained indicating an optimal assignment of the ads in the list A to the location nodes in N.

FIG. 2C depicts an example advertisement assignment scheme in an illustrative scenario according to one embodiment of the above process for purposes of the present patent application. A graph 200C including source (S) node 280 and a sink (T) node 286 is shown wherein at least a subset of a list of six ads (a(i)) 282 are to be assigned to four locations (n(i)) 284. An maximum flow solution shown in thicker lines illustrates assignment of a(1) to n(1), a(2) to n(2), a(3) to n(3) and a(6) to n(4) in the graph 200C of FIG. 2C. Skilled artisans will appreciate that more complex techniques may also take into consideration the bidding amounts by a DSP for the list of ads as well as the probability of an ad being “successful” (e.g., as per the feedback received from a native ad feedback module such as the learning module 268 shown in FIG. 2B) in an additional or alternative embodiment. In a still further variation, the learning/feedback module 268 may be configured to use the outcome of past interactions as well as placement/assignment recommendations and determine new success probabilities to be used by the placement module 252 for assignment/placement optimization. It should be further appreciated that techniques other than those based on graph theory may also be used in certain embodiments, e.g., involving multivariate linear programming, heuristics-based and meta heuristics-based techniques, etc.

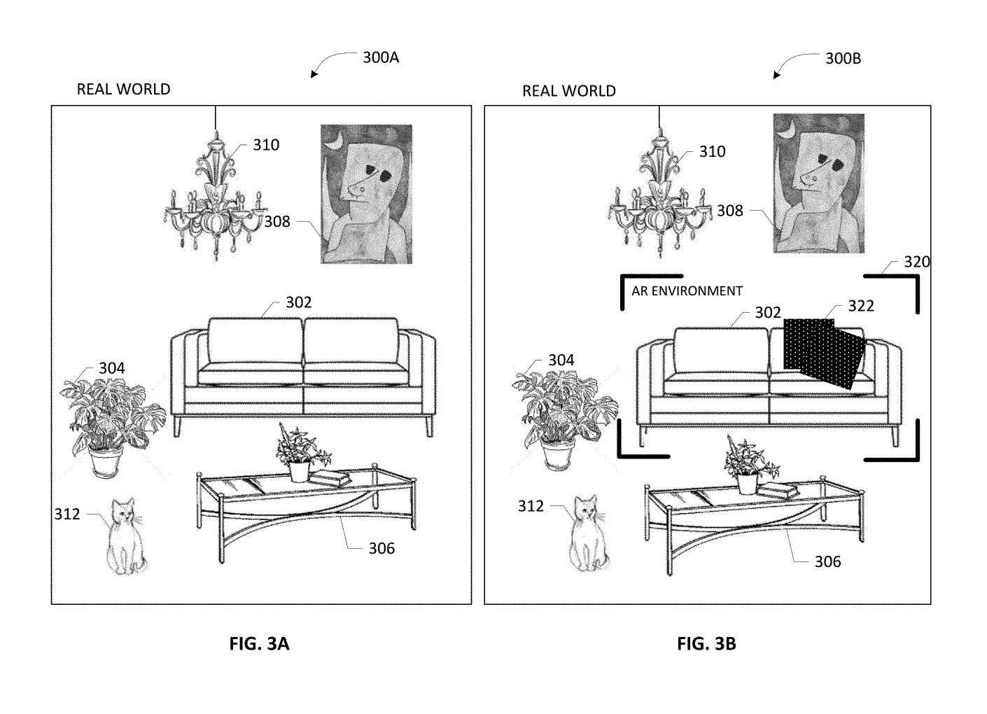

Turning to FIGS. 3A and 3B, depicted therein are an example real world environment 300A and an AR/MR environment 300B, respectively, where a native advertisement is positioned in relation to real world objects as viewed in a AR/MR display according to an embodiment of the present patent disclosure. Example real world environment 300A illustrates a scenario of several real world objects such as, e.g., chandelier 310, pet 312, painting 308, table 306, potted plant 304 and a sofa 302. Example AR/MR environment 300B includes at least a portion of the real world environment upon which AR content is projected via the display as an AR/MR view 320. Upon detecting and mapping a physical object, sofa 302, in the AR/MR viewing area 320, a selected/sponsored product to insert in the AR/MR environment is determined as a contextualized product e.g., a branded pair of pillows or fabric swatches, that is placed at a convenient location (e.g., near, on top of, or adjacent to, the sofa, as determined by APMS/ARNAP rules). A corresponding ad 322 illustrating the contextualized product may therefore be inserted into the AR content to be rendered accordingly, as illustrated in FIG. 3B.

Additional non-exhaustive and non-limiting example scenarios where an embodiment of the present invention may be practiced are set forth below.

### Example A

Sneakers recognition and advertisement matching:
The AR device continuously scans the environment and with the help of the Spatial Mapping System (SMS) gets a detailed representation of the environment.
During the above process, the AR device detects objects in the environment with the help of the Object and Sound Recognition System (ORS).
The AR Native Ads Platform (ARNAP) collects the above data and proceeds to the advertisement placement by calling the Ads Placement Management System (APMS).
For example, one of the recognized objects in the environment is a pair of sneakers placed on the floor, against the entrance wall.
The ARNAP applies rules (recommendations) from the APMS that finds the right type of advertisement that matches with the nature of the pair of sneakers. A set of options are presented and one of them is Adidas
The ARNAP selects the advertisement provided from the Ads Campaign Management System (ACMS) that corresponds to the rules received from the APMS. The proposed advertisement is the latest running shoes from Adidas.
The rules also provide options for the placement locations against the pair of shoes.
The advertised pair of shoes are then placed right next to the real pair of shoes, in an empty space.

### Example 2

Sound detection and advertisement matching for the mood:
The AR device continuously scans the environment and with the help of the SMS gets a detailed representation of the environment.
During the above process, the AR device detects sounds in the environment with the help of the ORS.
The ARNAP collects the above data and proceeds to the advertisement placement by calling the APMS.
The ORS system recognizes a Lady Gaga song in the environment.
The ARNAP applies placement rules from the APMS that find the right type of advertisement that matches with the nature of the song. A set of options are presented and one of them is an announcement to a concert.
The ARNAP gets the advertisement provided from the ACMS that corresponds to the rules (recommendation). This could be from pre-cached bids or not (as set forth in FIGS. 4A-4C). The proposed advertisement is a postcard featuring the concert of Lady Gaga in town.
The rules also provide options for the placement locations against a piece of furniture in the consumer's environment.
The digital postcard is then placed on a coffee table found in the consumer's living room.

### Example 3

Watching commercials on TV and matching the advertisement with an object in the real world:
The AR device continuously scans the environment and with the help of the SMS gets a detailed representation of the environment.
During the above process, the AR device detects objects in the environment with the help of the ORS.
In the meantime, a commercial break is playing on TV inside the consumer's living room.
The current advertised product is a brand of milk.
The ARNAP collects the data from the consumer's environment and proceeds to the advertisement placement by calling the APMS.
During the commercial break, the consumer goes to his kitchen and opens the fridge.
The ARNAP gets the advertisement provided from the ACMS. The proposed advertisement is a milk box being advertised on TV.
The ARNAP applies rules from the APMS that finds the right type of environment space or surface to place the digital milk box. A set of options are presented and one of them is to place next to the existing milk bottle recognized by the ORS.
The digital milk box is then placed right next to the milk bottle in the fridge.

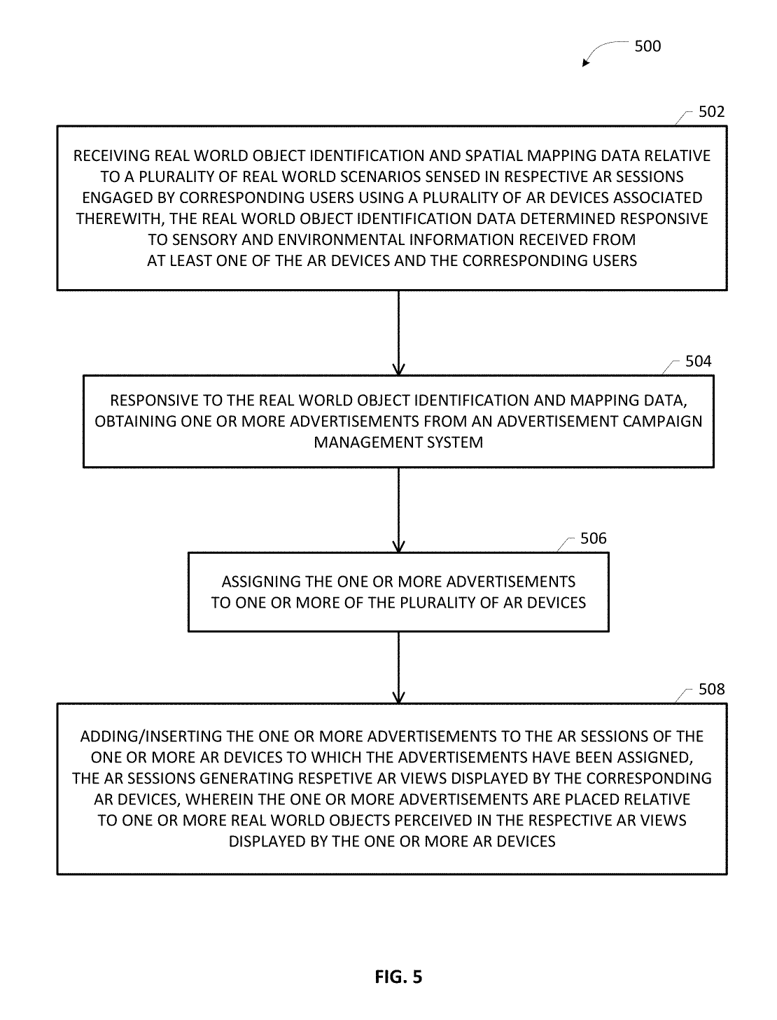

Turning to FIG. 5, depicted therein is a flowchart of various blocks, steps and/or acts that may be (re)combined in a high level process 500 for facilitating placement of native ads in an AR/MR environment according to an embodiment of the present patent application. At block 502, a suitable network node, entity, element in an AR advertisement architecture or an associated cloud-based implementation receives real world object identification data and spatial mapping data relative to a plurality of real world scenarios sensed in respective AR sessions engaged by corresponding users using a plurality of AR devices associated therewith. As described previously, the real world object identification data may be determined responsive to sensory and environmental information received from at least one of the AR devices and the corresponding users, mediated or facilitated through one or more sensory devices and gathered via local or remote ORS/SMS modules, components or elements. Responsive to the real world object identification and spatial mapping data, one or more advertisements are obtained from an advertisement campaign management system (block 504), which are assigned/placed to one or more of the plurality of AR devices, e.g., based on a flow optimization technique in a network graph constructed for the list of ads and AR device locations as nodes (block 506). The assigned advertisements are then added to the AR sessions of the one or more AR devices to which the advertisements have been assigned, wherein the AR sessions are operative to generate respective AR views displayed by the corresponding AR devices. As described previously, the one or more advertisements are placed (i.e., rendered) relative to the one or more real world objects perceived in the respective AR views displayed by the one or more AR devices (block 508).

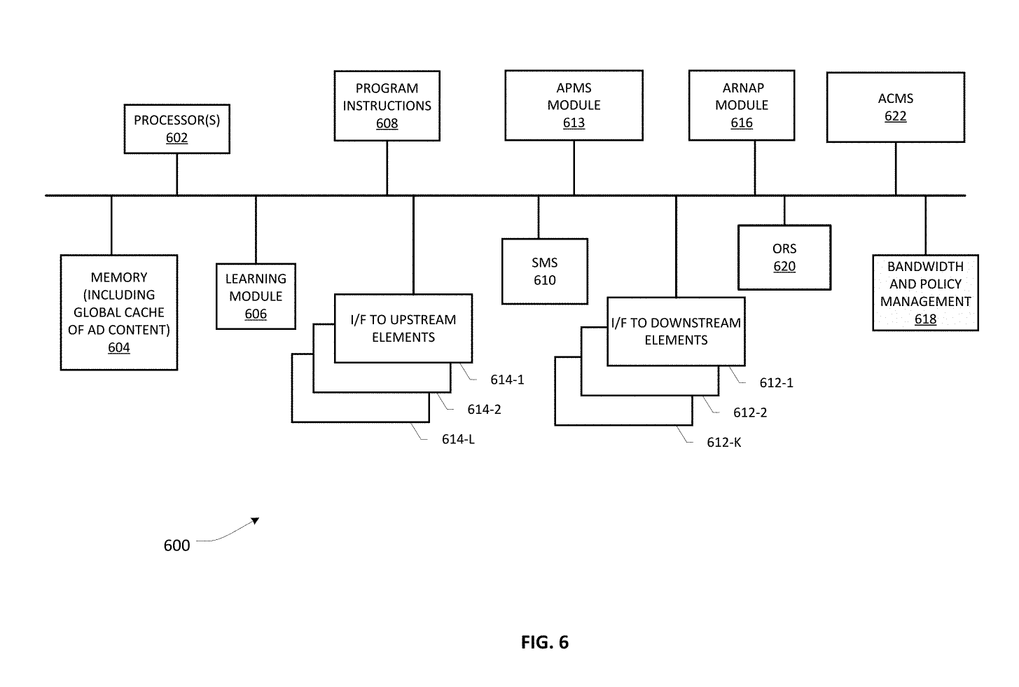

FIG. 6 depicts a block diagram of a computer-implemented apparatus, system, sub-system, or platform 600 that may be (re)configured and/or (re)arranged as a node or element in an example AR/MR network architecture according to one or more embodiments of the present patent disclosure for facilitating delivery and placement of real-time native advertisements using environmental and sensory recognition. It will be recognized by skilled artisans upon reference hereto that at least a portion of apparatus 600 may be configured as an ARNAP, an APMS, an SMS, and/or an ORS, or a combination thereof, to execute suitable program instructions stored on one or more persistent memory modules, e.g., modules 608, under control of one or more processors 602, for effectuating any of the processes relating to ad placement/assignment as well as placement training described hereinabove.

Accordingly, depending on implementation and/or network architecture of an AR media communications network and/or native ad architecture network, apparatus 600 may be configured in different ways suitable for operation at different hierarchical levels of a network infrastructure which may include a CDN and/or mobile broadcast network, e.g., at a super headend node, regional headend node, video hub office node, AR publisher server node, central or regional or edge distribution node(s), etc., on the basis of where AR source media feeds or other content sources are injected into an example deployment. Suitable network interfaces, e.g., I/F 614-1 to 614-L, may therefore be provided for effectuating communications with other network infrastructure elements and databases (e.g., AR media source feeds, global databases for storing AR media segments, metadata/manifest files, applicable digital rights management (DRM) entities, etc.), as well as one or more ACMS nodes, APMS/ORS/SMS nodes (where separately deployed), consumer profile databases and other third-party data sources, etc. In some embodiments, apparatus 600 may be configured as an integrated ad platform architecture including an ORS module 620 and/or SMS module 610. Interfaces 612-1 to 612-K for effectuating communications sessions with one or more downstream nodes, e.g., access network nodes and other intermediary network elements, subscriber premises nodes, AR subscriber devices, and the like. As noted above, one or more processors 602 may be provided as part of a suitable computer architecture for providing overcall control of the apparatus 600, which processor(s) 602 may be configured to execute various program instructions stored in appropriate memory modules or blocks, e.g., persistent memory having specific program instructions 608, including additional modules or blocks specific to AR ad selection, assignment, optimized placement, rendering, consumer-behavior based learning, etc. An ad content cache 604 may also be included in an example embodiment where ads forecasted based on previous learning may be stored. Where included, an APMS module 613 may include program instructions and related hardware for effectuating optimized ad placement and feedback-based learning as described in detail hereinabove. ARNAP functionality may also be embodied as a module or component 616 in an integrated ad platform architecture as one example configuration of apparatus 600. Where an implementation includes or otherwise associated as part of an SSP, ACMS functionality may be embodied as a module or component 622 of the integrated SSP architecture. Also, a learning module 606 may be separately provided from a placement module (e.g., in APMS 613) in one implementation. Additionally or optionally, where bandwidth management is provided in conjunction with AR ad policy management, appropriate functionality may be embodied as a module or component 618 as illustrated in FIG. 6.

Based on the foregoing, skilled artisans will recognize that embodiments of the present invention can advantageously place native ads in a contextualized manner relative to real world objects, entities, sounds, etc., as perceived by individual AR subscribers in respective AR environments. Whereas in a pure VR environment the content is already predetermined, and therefore ad placement can also be determined in advance, the AR environments can be dynamically changing, thus requiring real-time object identification and spatial mapping. Embodiments of the present invention not only address this technological need but also facilitate ad placement in an optimized manner based on a weighted flow maximization process. Accordingly, overall bandwidth consumption of AR flows including native ads in a network can be optimized as well.

Further beneficial features of an embodiment may include one or more of the following: (i) real-time non-intrusive (i.e., native) advertisement experience even in dynamically varying AR/MR environments; (ii) better placement of targeted ads based on consumer's environment and profile; (iii) customizable ads placement rules and ad management based on policies; (iv) continuous learning from past ads placement results (e.g., the interaction from the consumer) to improve the real-time ad insertion techniques; (v) continuous improvement of the learning by a feedback sensing component; (vi) scalable architecture that can be deployed in a cloud-centric implementation; (vii) flexibility of deployment since the processing for detecting objects, sounds and environment could be either hosted on the AR device or located in the network/cloud; (viii) enhanced adaptability of the architecture because new sensing components and/or new AR rendering such as tactile rendering can be readily integrated into an AR environment; and (ix) implementation of cloud-based security to assure user privacy and anonymization.

One skilled in the art will recognize that various apparatuses, subsystems, AR functionalities/applications, ad exchange network elements, and/or endpoint AR nodes as well as the underlying network infrastructures set forth above may be architected in a virtualized environment according to a network function virtualization (NFV) architecture in additional or alternative embodiments of the present patent disclosure. For instance, various physical resources, databases, services, applications and functions executing within an example network of the present application, including ARNAP, ORS, SMS, APMS, and ACMS functionalities, etc., may be provided as virtual appliances, machines or functions, wherein the resources and applications are virtualized into suitable virtual network functions (VNFs) or virtual network elements (VNEs) via a suitable virtualization layer. Resources comprising compute resources, memory resources, and network infrastructure resources are virtualized into corresponding virtual resources wherein virtual compute resources, virtual memory resources and virtual network resources are collectively operative to support a VNF layer, whose overall management and orchestration functionality may be supported by a virtualized infrastructure manager (VIM) in conjunction with a VNF manager and an NFV orchestrator. An Operation Support System (OSS) and/or Business Support System (BSS) component may typically be provided for handling network-level functionalities such as network management, fault management, configuration management, service management, and subscriber management, etc., which may interface with VNF layer and NFV orchestration components via suitable interfaces.

Furthermore, at least a portion of an example network architecture disclosed herein may be virtualized as set forth above and architected in a cloud-computing environment comprising a shared pool of configurable virtual resources. Various pieces of hardware/software associated with ARNAP, ORS, SMS, APMS, and ACMS functionalities, and the like may be implemented in a service-oriented architecture, e.g., Software as a Service (SaaS), Platform as a Service (PaaS), infrastructure as a Service (IaaS) etc., with multiple entities providing different features of an example embodiment of the present invention, wherein one or more layers of virtualized environments may be instantiated on commercial off the shelf (COTS) hardware. Skilled artisans will also appreciate that such a cloud-computing environment may comprise one or more of private clouds, public clouds, hybrid clouds, community clouds, distributed clouds, multiclouds and interclouds (e.g., “cloud of clouds”), and the like.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and may not be interpreted in an idealized or overly formal sense expressly so defined herein.

At least some example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. Such computer program instructions may be provided to a processor circuit of a general purpose computer circuit, special purpose computer circuit, and/or other programmable data processing circuit to produce a machine, so that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Additionally, the computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

As pointed out previously, tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray). The computer program instructions may also be loaded onto or otherwise downloaded to a computer and/or other programmable data processing apparatus to cause a series of operational steps to be performed on the computer and/or other programmable apparatus to produce a computer-implemented process. Accordingly, embodiments of the present invention may be embodied in hardware and/or in software (including firmware, resident software, micro-code, etc.) that runs on a processor or controller, which may collectively be referred to as “circuitry,” “a module” or variants thereof. Further, an example processing unit may include, by way of illustration, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGA) circuits, any other type of integrated circuit (IC), and/or a state machine. As can be appreciated, an example processor unit may employ distributed processing in certain embodiments.

Further, in at least some additional or alternative implementations, the functions/acts described in the blocks may occur out of the order shown in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Furthermore, although some of the diagrams include arrows on communication paths to show a primary direction of communication, it is to be understood that communication may occur in the opposite direction relative to the depicted arrows. Finally, other blocks may be added/inserted between the blocks that are illustrated.

It should therefore be clearly understood that the order or sequence of the acts, steps, functions, components or blocks illustrated in any of the flowcharts depicted in the drawing Figures of the present disclosure may be modified, altered, replaced, customized or otherwise rearranged within a particular flowchart, including deletion or omission of a particular act, step, function, component or block. Moreover, the acts, steps, functions, components or blocks illustrated in a particular flowchart may be inter-mixed or otherwise inter-arranged or rearranged with the acts, steps, functions, components or blocks illustrated in another flowchart in order to effectuate additional variations, modifications and configurations with respect to one or more processes for purposes of practicing the teachings of the present patent disclosure.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A method for facilitating placement of native advertisements in an augmented reality (AR) environment, the method comprising:
receiving real world object identification and spatial mapping data relative to a plurality of real world scenarios sensed in respective AR sessions engaged by corresponding users using a plurality of AR devices associated therewith, the real world object identification and spatial mapping data determined responsive to sensory and environmental information received from at least one of the AR devices and the corresponding users;
responsive to the real world object identification and spatial mapping data, obtaining one or more advertisements from an advertisement campaign management system;
assigning the one or more advertisements to one or more of the plurality of AR devices; and
adding the one or more advertisements to the AR sessions of the one or more AR devices to which the advertisements have been assigned, the AR sessions generating respective AR views displayed by the corresponding AR devices, wherein the one or more advertisements are placed relative to one or more real world objects perceived in the respective AR views displayed by the one or more AR devices.

2. The method as recited in claim 1, wherein the assigning of the one or more advertisements is based on optimizing a flow metric associated with a logical graph constructed for the plurality of AR devices.

3. The method as recited in claim 1, wherein the one or more advertisements are obtained from the advertisement campaign management system responsive to pre-cached bids via an advertisement exchange entity.

4. The method as recited in claim 1, wherein the one or more advertisements are obtained from the advertisement campaign management system responsive to real-time bidding via an advertisement exchange entity in a dynamical manner.

5. The method as recited in claim 1, further comprising:
receiving user-interaction information from the one or more AR devices regarding how the users interact with the advertisements placed in respective AR sessions; and
utilizing the user-interaction information to generate feedback control signals to further refine at least one of future advertisement selection, assignment and placement steps.

6. The method as recited in claim 5, wherein the user-interaction information comprises at least one of a user's gaze behavior with respect to an advertisement placed in the user's AR view and the user's input device behavior with respect to the advertisement placed in the user's AR view.

7. The method as recited in claim 1, wherein the sensory and environmental information comprises data generated by at least one of cameras, microphones, accelerometers, Global Positioning System (GPS) locators, touch sensors, IoT sensors, olfactory sensors, mood sensors, temperature sensors, pressure sensors, gesture sensors, head movement detectors, ocular movement trackers, directional sensors, past environmental data, and present environmental data associated with one or more of the AR devices.

8. The method as recited in claim 1, wherein the one or more advertisements comprise native advertisements relative to at least one of the real world scenarios and AR content presented in the AR views of the respective AR sessions.

9. The method as recited in claim 1, wherein the one or more advertisements are determined further responsive to at least one of user profiles, weather data pertaining to a geographic location where an AR device is located and news information.

10. The method as recited in claim 1, further comprising:
initializing AR devices when an AR device is turned on; and
providing default content to the AR device depending on an AR application executed on the AR device upon initialization.

11. A system for facilitating placement of native advertisements in an augmented reality (AR) environment, the system comprising:
one or more processors; and
one or more persistent memory modules having program instructions stored thereon which, when executed by the one or more processors, perform the following in association with one or more modules:
receiving real world object identification and spatial mapping data relative to a plurality of real world scenarios sensed in respective AR sessions engaged by corresponding users using a plurality of AR devices associated therewith, the real world object identification and spatial mapping data determined responsive to sensory and environmental information received from at least one of the AR devices and the corresponding users;
obtaining one or more advertisements from an advertisement campaign management system responsive to the real world object identification and spatial mapping data;
assigning the one or more advertisements to one or more of the plurality of AR devices; and
adding the one or more advertisements to the AR sessions of the one or more AR devices to which the advertisements have been assigned, the AR sessions generating respective AR views displayed by the corresponding AR devices, wherein the one or more advertisements are placed relative to one or more real world objects perceived in the respective AR views displayed by the one or more AR devices.

12. The system as recited in claim 11, wherein the program instructions for assigning the one or more advertisements comprise instructions for assigning the one or more advertisements based on optimizing a flow metric associated with a logical graph constructed for the plurality of AR devices.

13. The system as recited in claim 11, wherein the program instructions obtaining the one or more advertisements comprise instructions for obtaining advertisements from the advertisement campaign management system responsive to pre-cached bids via an advertisement exchange entity.

14. The system as recited in claim 11, wherein the program instructions obtaining the one or more advertisements comprise instructions for obtaining advertisements from the advertisement campaign management system responsive to real-time bidding via an advertisement exchange entity in a dynamical manner.

15. The system as recited in claim 11, wherein the program instructions further comprise instructions configured for performing:
processing user-interaction information received from the one or more AR devices regarding how the users interact with the advertisements placed in respective AR sessions; and
utilizing the user-interaction information to generate feedback control signals to further refine at least one of future advertisement selection, assignment and placement steps.

16. The system as recited in claim 15, wherein the user-interaction information comprises at least one of a user's gaze behavior with respect to an advertisement placed in the user's AR view and the user's input device behavior with respect to the advertisement placed in the user's AR view.

17. The system as recited in claim 11, wherein the sensory and environmental information comprises data generated by at least one of cameras, microphones, accelerometers, Global Positioning System (GPS) locators, touch sensors, IoT sensors, olfactory sensors, mood sensors, temperature sensors, pressure sensors, gesture sensors, head movement detectors, ocular movement trackers, directional sensors, past environmental data, and present environmental data associated with one or more of the AR devices.

18. The system as recited in claim 11, wherein the one or more advertisements comprise native advertisements relative to at least one of the real world scenarios and AR content presented in the AR views of the respective AR sessions.

19. The system as recited in claim 11, wherein the program instructions further comprise instructions configured for determining the one or more advertisements further responsive to at least one of user profiles, weather data pertaining to a geographic location where an AR device is located and news information.

20. The system as recited in claim 11, wherein the program instructions further comprise instructions configured for performing:
initializing AR devices when an AR device is turned on; and
providing default content to the AR device depending on an AR application executed on the AR device upon initialization.
